(19) United States
(12) Patent Application Publication
(10) Pub. No.: US 2019/0110410 A1
(43) Pub. Date: Apr. 18, 2019

(54) STUMP GRINDER

(71) Applicant: BlueBird Turf Products LLLP, Auburn Hills, MI (US)

(72) Inventors: Anthony Joseph Carmen, JR., Bloomfield Hills, MI (US); Nicholas Anthony Salvatore, Shelby Township, MI (US)

(21) Appl. No.: 16/164,548

(22) Filed: Oct. 18, 2018

Related U.S. Application Data
(60) Provisional application No. 62/574,074, filed on Oct. 18, 2017.

(51) Int. Cl. A01G 23/06

(52) U.S. Cl. CPC A01G 23/067

(57) ABSTRACT

A manually operated stump grinder includes a turret system configured for substantially symmetric rotation by configuring the device such that the belt drive housing remains above and/or forward of the drive wheel during turret rotation.

### RELATED APPLICATIONS

This application claims the benefit of and priority to U.S. Provisional Patent Application Ser. No. 62/574,074 filed Oct. 18, 2017, and entitled “Stump Grinder”, the entire disclosure of which is hereby incorporated by this reference.

### TECHNICAL FIELD

The present invention relates, generally, to a manually operated stump grinder and, more particularly, to a turret system configured for substantially symmetric rotation.

### BACKGROUND

Presently known stump grinders mount a motor and a cutting wheel on a turret, with a belt connecting the motor output to the cutter. The belt is typically enclosed in a housing connected alongside the chassis for operation within a substantially vertical plane. However, presently known belt housings tend to interfere with the rear wheel, limiting rotation in at least one rotational direction.

Current stump grinder designs also limit the user's view of the stump during grinding, by positioning the motor along the line of sight between the operator and the stump. In addition, existing stump grinders employ a cutting wheel assembly comprising multiple components, resulting in costly manufacturing and maintenance costs.

Finally, presently known stump grinder designs do not permit the unit to be folded into a compact form-factor for stowage and shipping.

Systems and methods are thus needed which overcome these limitations.

Various features and characteristics will also become apparent from the subsequent detailed description and the appended claims, taken in conjunction with the accompanying drawings and this background section.

### BRIEF SUMMARY

Various embodiments of the present invention contemplate an upright, portable, hand operated stump grinder having a belt housing configured such that it does not interfere with the wheel as the turret pivots from side-to-side. In an embodiment, the belt drive housing is disposed above and/or forward of the wheel to avoid interference between the wheel and the belt drive housing during turret rotation. In this way the turret may exhibit substantially symmetrical rotation in the range of about 22° to 30° in both directions (left-to-right and right-to-left). The stump grinder can be configured with a turret pivot pin having a vertical axis disposed forwardly of the drive wheel axis by a distance in the range of about two to six inches.

In some configurations, the design of the stump grinder allows the operator to view the stump during grinding, by positioning the motor within an envelope that does not interfere with the operator's line of sight to the stump. For example, the motor can be mounted within a zone that is equal to or less than approximately twenty-four to thirty-six inches from the ground, and not more than two to eight inches forward of the wheel axis.

Various embodiments provide a stumper grinder having foldable handles for reducing the height profile during shipping and storage. Some configurations provide a stump grinder having a single piece grinding wheel.

Various other embodiments, aspects, and features are described in greater detail below.

### BRIEF DESCRIPTION OF THE DRAWING FIGURES

Exemplary embodiments will hereinafter be described in conjunction with the following drawing figures, wherein like numerals denote like elements, and:

FIG. 1 is a right side elevation view of an exemplary stump grinder in accordance with various embodiments;

FIG. 2 is a front perspective view of the stump grinder of FIG. 1 in accordance with various embodiments;

FIG. 3 is a perspective view of the stump grinder of FIGS. 1 an 2 in accordance with various embodiments;

FIG. 4 is a close up view of the turret system of the stump grinder of FIGS. 1-3 in accordance with various embodiments;

FIG. 5 is a right side elevation view of the stump grinder of FIG. 1 with the right wheel removed, illustrating that the vertical turret axis is disposed forwardly of the horizontal wheel axis in accordance with various embodiments;

FIG. 6 is a top plan view of the stump grinder of FIGS. 1-3 illustrating a substantially symmetrical arc swept by the turret from a forward facing centerline in accordance with various embodiments;

FIG. 7 is a close up view of the belt housing disposed above and forward of the left wheel in accordance with various embodiments;

FIG. 8 is a perspective view of the belt housing in accordance with various embodiments;

FIG. 9 is a left side elevation view of the stump grinder of FIG. 1 in accordance with various embodiments;

FIG. 10 is a perspective view of the stump grinder handle showing the top hand grip portion pivoted forward to reduce the device profile in accordance with various embodiments;

FIG. 11 is a perspective view of the stump grinder handle showing the intermediary ladder portion pivoted forward to further reduce the device profile in accordance with various embodiments; and

FIG. 12 is a close up view of the stump grinder handle illustrating a linkage mechanism for unlocking a pivot junction coupled to the intermediary ladder portion of the handle in accordance with various embodiments.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

Various embodiments of the present invention relate to an improved stump grinder design.

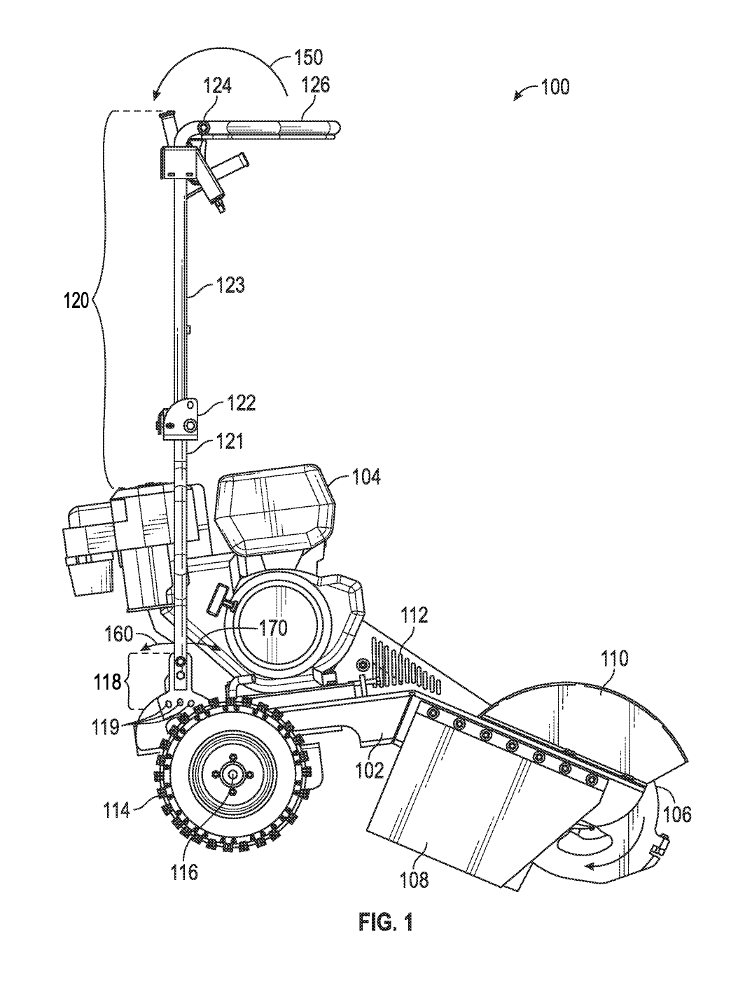

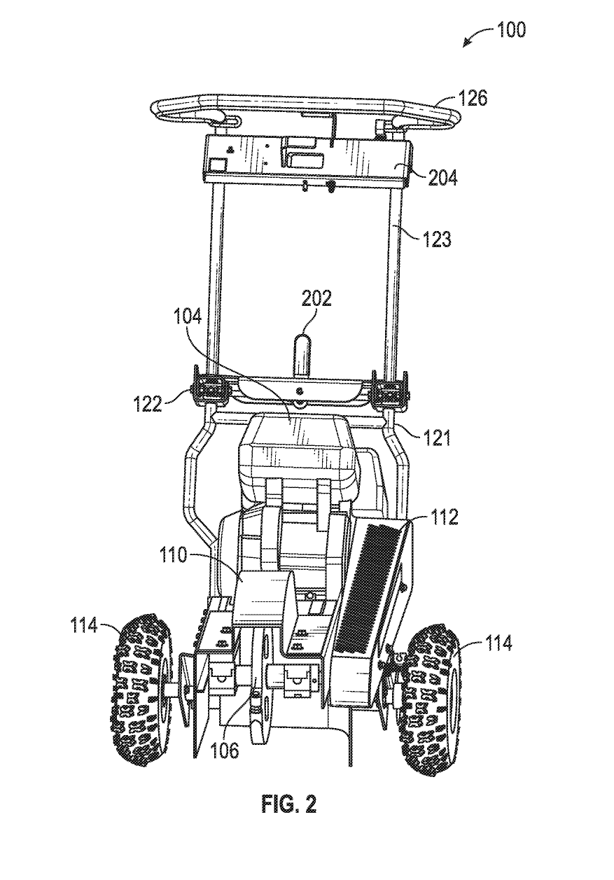

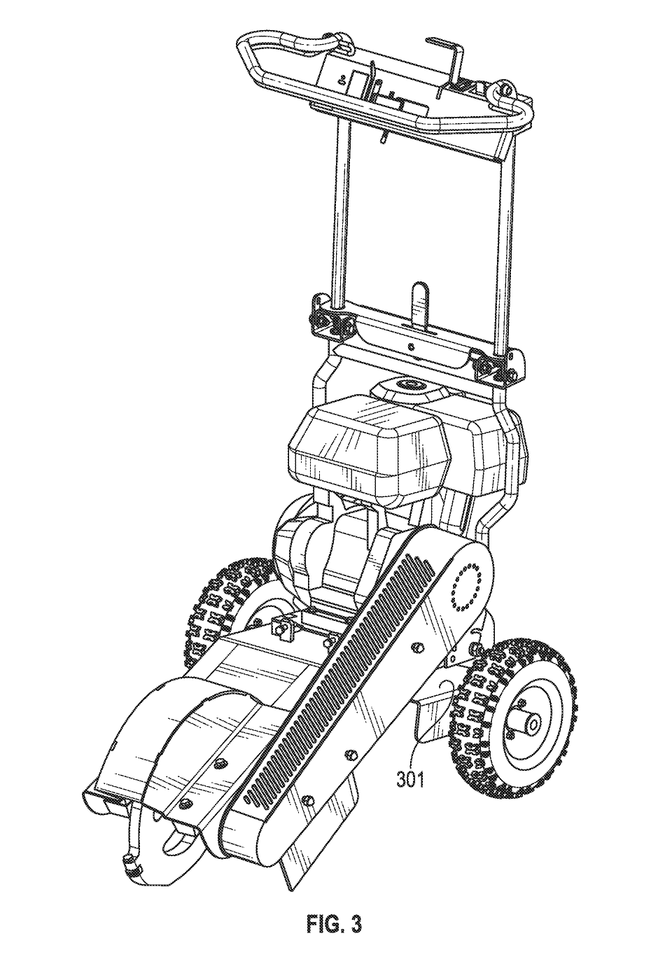

Referring now to FIGS. 1-3, an exemplary stump grinder 100 includes a motor 104 and a grinding or cutting wheel 106 mounted to a chassis 102. The motor 104 drives the grinding wheel 106 through a belt drive system (not shown) housed within a belt drive housing 112. Radial chip guard no and one or more lateral chip guards 108 form a barrier to contain flying wood chips as they are thrust rearward and outward by the grinding wheel 106. The chassis 102 is mounted to a turret platform to allow the operator to swing the grinding wheel 106 from side to side over a stump while the drive wheels 114 are locked about their wheel axel (axis 116). In various embodiments, either one of the drive wheels 114 may be selectively locked to allow the entire stump grinder 100 to pivot about the locked wheel 114.

A handle assembly 120 is mounted to the chassis 102 at a base pivot connection 118. The base pivot connection 118 can be unlocked and the handle assembly 120 can be rotated (in the direction of arrow 160) and locked into an operation mode. Alternatively, the base pivot connection 118 can be unlocked and the handle assembly 120 can be rotated (in the direction of arrow 170) and locked into a storage position. The base pivot connection 118 can comprise a plurality of holes 119, which allows the handle assembly 120 to be rotated (in the direction of arrow 160) and locked in the operation mode in one of a multitude of different angles.

The handle assembly 120 includes a lower ladder portion 121 connected to an upper ladder portion 123 at a pivot junction 122. In addition, the handle assembly 120 includes a handle portion 126 connected to ladder portion 123 at a pivot point 124. As illustrated, the handle portion 126 is in a storage position. The handle portion 126 can be pivoted (in the direction of arrow 150) and then secured for operation of the stump grinder 100.

A lever 202 is coupled to a linkage mechanism configured to unlock the pivot junction 122. A control panel 204 is coupled to the upper ladder portion 123. The control panel 204 can be configured to control one or more of the motor 104, the drive wheels 114, the grinding wheel 106, the base pivot connection 118, and a turret system.

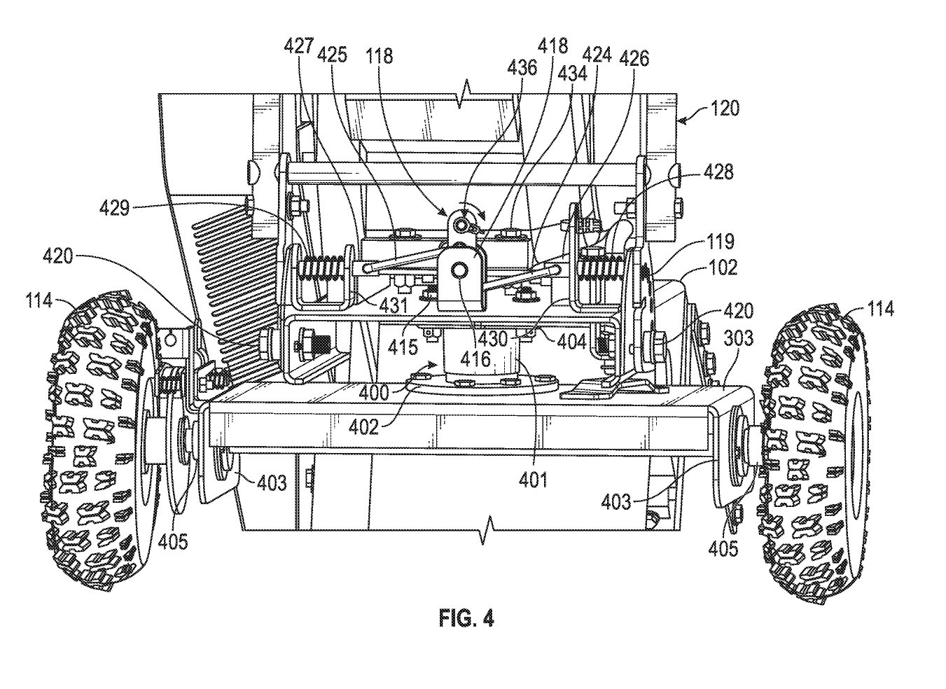

FIG. 4 is a detail view of the stump grinder 100 illustrating the base pivot connection 118 and a turret system 400 in accordance with various embodiments. The base pivot connection 118 includes base linkage mechanism 415, the plurality of holes 119, and a pivot point 420. The handle assembly 120 is mounted to the chassis 102 at the pivot point 420 of the base pivot connection 118.

The base linkage mechanism 415 includes a pair of posts 426, 427, each wrapped with a spring 428, 429 locked in a U-shaped flange 430, 431. When the base pivot connection 118 is locked, the pair of posts 426, 427 extend through at least one of the plurality of holes 119 on either side of the connection 118. On an end distal to the plurality of holes 119, each of the pair of posts 426, 427 is coupled to a linkage member 424, 425, are coupled to a lever 418. One of the linkage members 424 is coupled to the lever 418 below a pivot point 416 and the other linkage member 425 is coupled to the lever 418 above the pivot point 416. The lever 418 is connected to a cable 434, which is in communication with the control panel 204.

When the cable 434 is actuated, the lever 418 rotates (in the direction of arrow 436), the posts 426, 427 are released from the plurality of holes 119 thus unlocking base pivot connection 118 and allowing movement of the handle assembly 120 to the operation mode or the storage position. Once the handle assembly 120 has been moved to a desired position for operation or for storage, the cable 434 is released, and the posts 426, 427 are moved by the springs 428, 429 into one of the plurality of holes 119, thus locking the handle assembly 120 in the desired position.

The turret system 400 includes a turret 401, which is mounted to the turret platform 303 at a first mount 402 and is mounted to the chassis 102 at a second mount 404. The turret platform 303 includes respective side brackets 403 through which a drive axle 405 is connected. The turret 400 allows the entire chassis 102 (including the motor 104 and the grinding wheel 106) to pivot with respect to the turret platform 303 (including the stationary wheels 114).

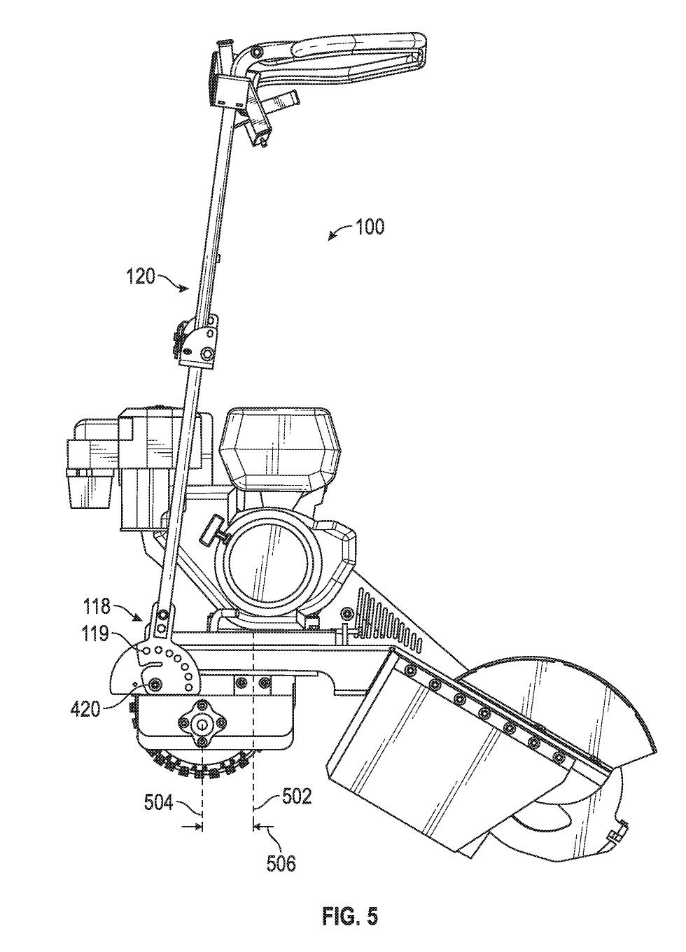

Referring now to FIG. 5, a vertical turret axis 502 of the stump grinder 100 is disposed forwardly of the horizontal wheel axis 504 by a distance 506. As described in greater detail, this forward displacement of the turret axis 502 relative to the drive wheel axis 504 facilitates improved side-to-side motion of the grinding wheel 106 during stump grinding. In some configurations, the distance 506 is in the range of one to six inches. In one configuration, the distance 506 is about three inches.

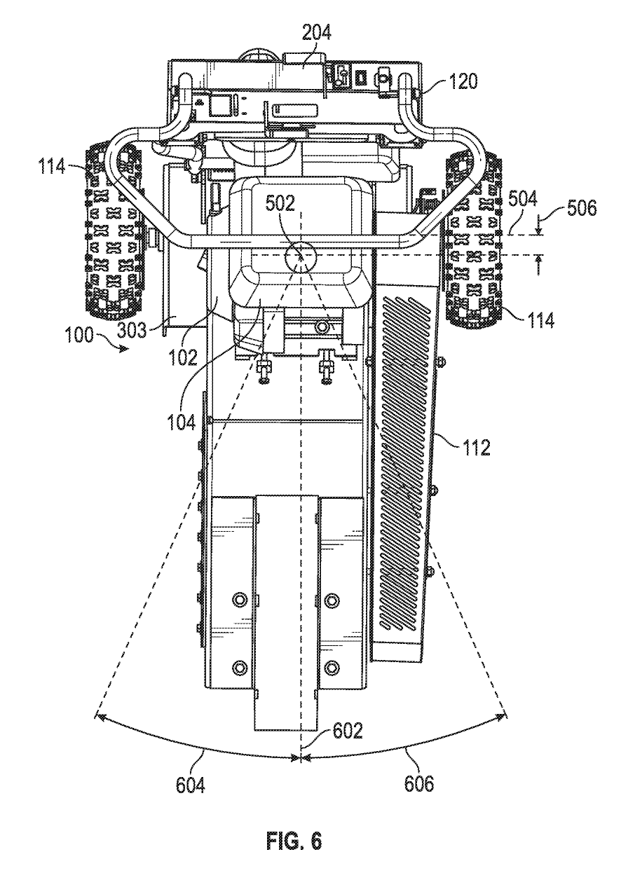

FIG. 6 is a top plan view of the stump grinder 100 of FIGS. 1-3 illustrating a substantially symmetrical arc swept by the turret system 400. More particularly, a centerline 602 extends forwardly through the turret axis 502. By disposing the turret axis 502 forward of the drive wheel axis 504, and further by disposing the belt housing 112 above and/or forward of the drive wheel 114, a substantially symmetric arc (for example, first arc 604 and second arc 606) may be swept by the chassis 102 about the centerline 602. In some configurations, the first arc 604 and the second arc 606 are each in the range of 20 to 30 degrees. In one configuration, the first arc 604 and the second arc 606 are each about 26 degrees.

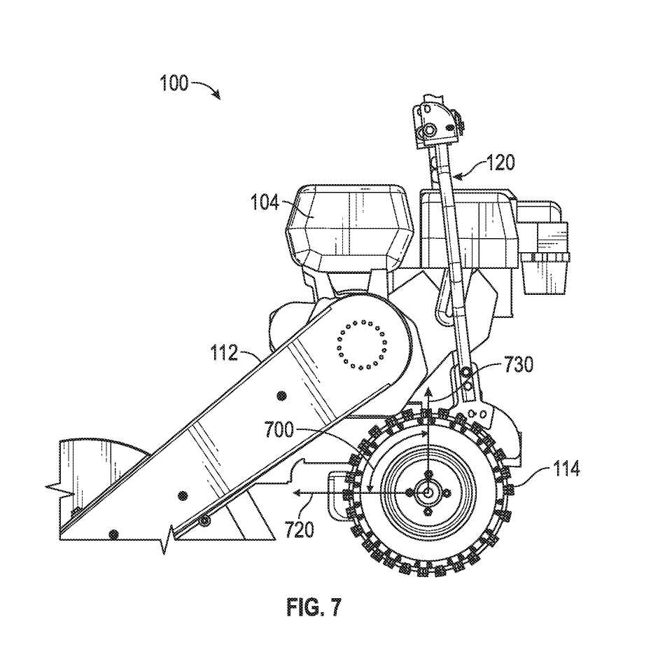

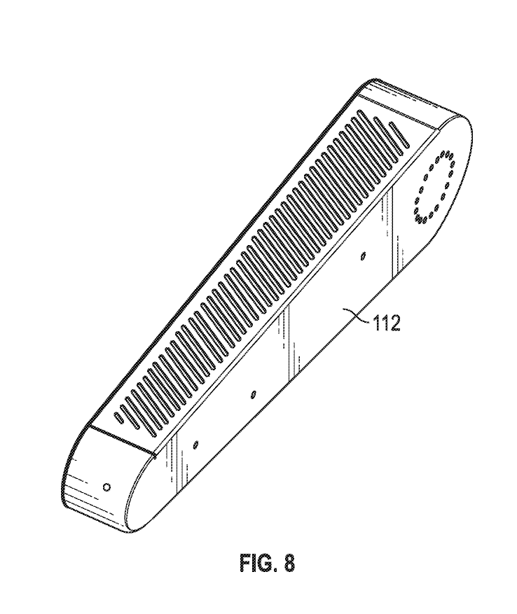

FIG. 7 and FIG. 8 illustrate examples of the belt housing 112. In various embodiments, the belt housing 112 is disposed above and forward of the left wheel 114. More particularly, all points on the surface of housing 112, and especially all points on the underside thereof, are either forward (in the direction of arrow 720) of or above (in the direction of arrow 730) the perimeter of the wheel 114. In this way, the turret system 400 allow the chassis 102 to swing to an operator's left (along arc 606 in FIG. 6), unimpeded by any contact between the belt housing 112 and the drive wheel 114. Specifically, all points on the surface of the belt housing 112 are spaced apart from toe arc segment 700 along the outer circumference of the wheel 114 as the chassis 102 (including the motor 104, the grinding wheel 106, and the belt housing 112) traverses arc 606.

In accordance with a further aspect of the present invention, the stump grinder 100 is configured to allow the operator to see over the motor 104 and view the stump during grinding. This is facilitated by placing the motor 104 below the operator's line of sight to the stump.

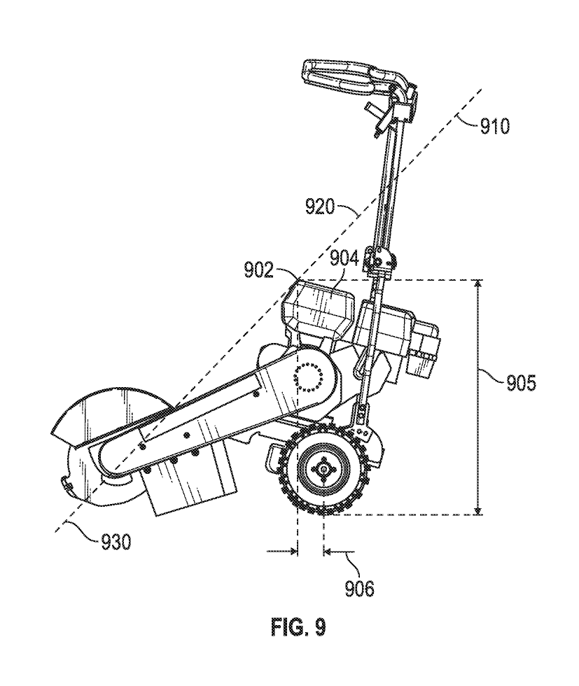

More particularly and referring now to FIG. 9, the stump grinder 100 may be configured such that the entire motor 104 is disposed below and to the right of a line of sight 920 extending between the operator's viewpoint 910 and the stump site 930. That is, the highest point 902 on the motor 104 is: i) no higher than a height limit dimension 905; and ii) forward of the drive wheel axis 504 by no more than a distance 506. In some configurations, the height dimension 905 is in the range of 24 to 36 inches. In some configurations, the height dimension 905 is preferably about 30 to 32 inches. In one configuration, the height dimension 905 is about 30.86 inches. In some configurations, the distance 506 is suitably in the range of about 1 to 8 inches. In some configurations, the distance 506 is in the range preferably about 3 to 6 inches. In one configuration, the distance 506 is about 4.5 inches.

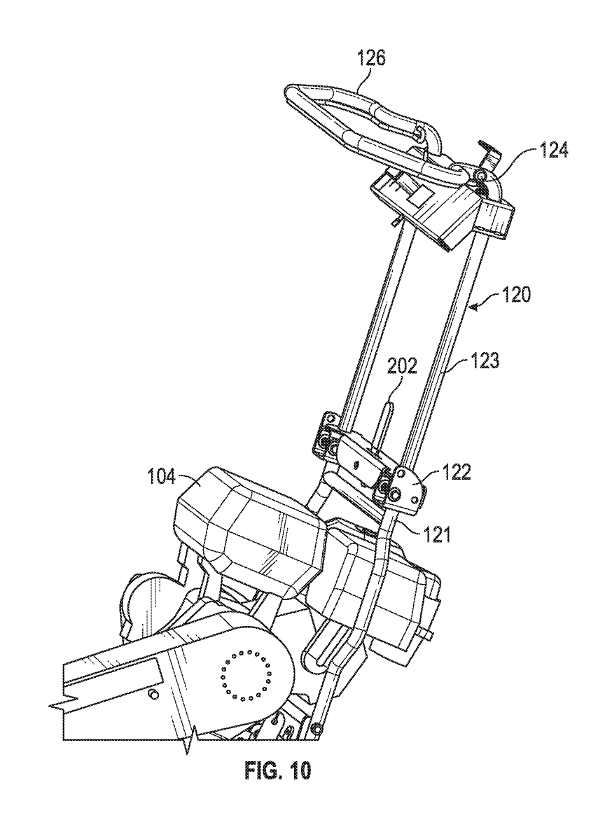

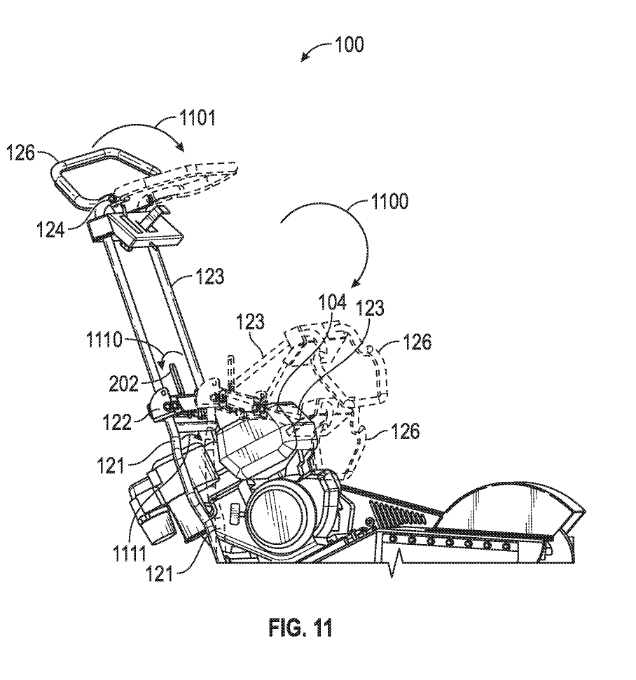

Referring to FIGS. 10-12, the handle assembly 120 of the stump grinder 100 can folded into a compact form-factor for stowage and shipping. As illustrated in FIG. 1i, the handle assembly 120 of the stump grinder 100 can be in the operation mode (as illustrated by solid lines for the handle assembly 120) or in a storage position (as illustrated by the hashed lines for the handle assembly 120).

The hand grip portion 126 can pivoted forward at pivot point 124 (in the direction of arrow 1101) into a storage position for the hand grip portion 126. In addition, the lever 202 can be rotated (in the direction of arrow 1110) to unlock the pivot junction 122 and the intermediary ladder portion 123 can be pivoted forward (in the direction of arrow 1100) to further reduce the device profile. Finally, the cable 434 can be actuated (see FIG. 4) to unlock the base pivot connection 118 and the handle assembly 120 can be pivoted forward (in the direction of arrow 1111) in the storage position, as previously discussed.

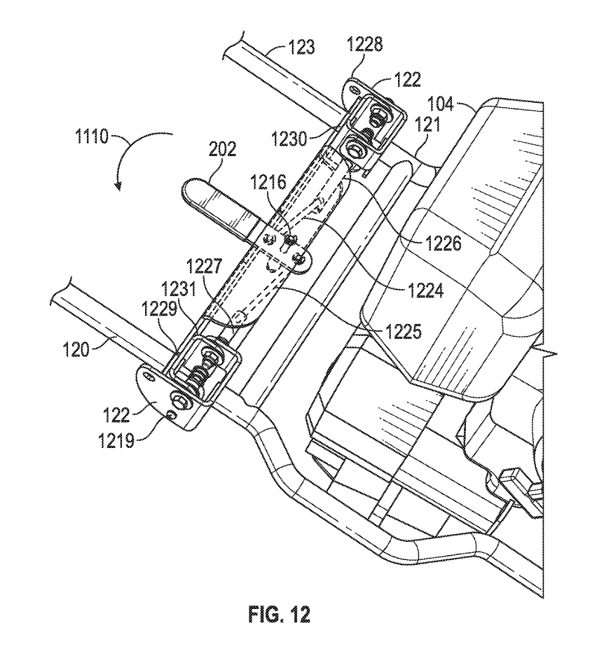

The lever 202 is coupled to a linkage mechanism configured to unlock the pivot junction 122. With reference to FIG. 12, the storage linkage mechanism 1215 includes a pair of posts 1226, 1227, each wrapped with a spring 1228, 1229 locked in a U-shaped flange 1230, 1231. When the pivot junction 122 is locked, the pair of posts 1226, 1227 extend through a hole 1219 through an outer surface of the pivot junction 122. On an end distal to the hole 1219, each of the pair of posts 1226, 1227 is coupled to a linkage member 1224, 1225, are coupled to a lever 418. One of the linkage members 1224 is coupled to the lever 202 below a pivot point 1216 and the other linkage member 1225 is coupled to the lever 202 above the pivot point 1216.

When the lever 202 is rotated (in the direction of arrow 1110), the posts 1226, 1227 are released from the holes 1219 thus unlocking the handle assembly 120 and allowing movement of the intermediary ladder portion 123 to the storage position or back to the operation mode. Once the handle assembly 120 has been moved to a desired position for storage or for operation, the lever 202 is released, and the posts 1226, 1227 are moved by the springs 1228, 1229 into the holes 1219, thus locking the handle assembly 120 in the desired position.

A stump grinder is provided which includes: a drive wheel axel defining a drive wheel axis; respective first and second drive wheels mounted to respective distal ends of the drive wheel axel; a motor; a stump cutter; a drive system interconnecting the motor and the cutter; a housing configured to substantially enclose the drive system; and a turret assembly configured to simultaneously pivot the motor, stump cutter, drive system, and housing about a second axis substantially orthogonal to the drive wheel axis. In an embodiment, the housing is configured to avoid contact with the first and second drive wheels as the turret undergoes substantially symmetrical rotation.

In an embodiment the housing is disposed proximate the first drive wheel at least one of above and forward of the first drive wheel to thereby avoid interference between the first drive wheel and the housing during turret rotation.

In an embodiment the turret rotation comprises traversing substantially equal arc segments from right-to-left and from left-to-right.

In an embodiment each of the substantially equal arc segments is in the range of about 22° to 30°.

In an embodiment each of the substantially equal arc segments is in the range of about 26°.

In an embodiment the cutter comprises a cutting wheel configured to rotate in a substantially vertical plane.

In an embodiment the drive system comprises a belt configured to apply torque from the motor to the cutting wheel.

In an embodiment the turret assembly comprises a turret pivot pin substantially defining the second axis.

In an embodiment the turret pivot pin is disposed forwardly of the drive wheel axis.

In an embodiment the turret pivot pin is disposed forwardly of the drive wheel axis by a distance in the range of about two to six inches.

In an embodiment the motor is disposed within an envelope that does not interfere with the operator's line of sight to the stump.

In an embodiment the motor is mounted within a zone that is equal to or less than approximately twenty-four to thirty-six inches above the ground.

In an embodiment the motor is further mounted within a zone that is not more than two to eight inches forward of the drive wheel axis.

In an embodiment the motor is mounted within a zone that is approximately thirty inches above the ground and approximately five inches forward of the drive wheel axis.

In an embodiment the stump grinder further includes a foldable manual drive handle configured to selectively reduce the height profile of the stump grinder.

In an embodiment the foldable manual drive handle comprises a handle portion, a ladder portion, and an actuator configured to selectively pivot the ladder portion into a folded position.

A stump grinder is also provided which includes: a turret assembly having a top portion mounted to a chassis and a bottom portion mounted to a drive wheel axel assembly; a drive wheel mounted to a first side of the drive wheel axel assembly; a motor mounted to the chassis; a cutter mounted to the chassis; and a belt drive housing mounted proximate the first side of the drive wheel axel assembly and interconnecting the motor and the cutter.

In an embodiment the housing is disposed forward of and above the drive wheel to thereby avoid contact with the first and second drive wheels as the turret assembly pivots symmetrically.

In an embodiment the turret assembly is configured to pivot about symmetrically about substantially equal arc segments in the range of about 22° to 30°.

In an embodiment the turret pivot axis is disposed forwardly of the drive wheel axis by a distance in the range of about two to six inches.

In an embodiment the motor is mounted within a zone that is approximately thirty inches above the ground and approximately five inches forward of the drive wheel axel

It should be noted that the various inventions described herein, while illustrated in the context of a one cylinder engine four stroke engine, are not so limited. Those skilled in the art will appreciate that the systems and methods described herein may contemplate any number of cylinders.

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

1. A stump grinder comprising:
a drive wheel axel defining a drive wheel axis;
respective first and second drive wheels mounted to respective distal ends of the drive wheel axel;
a motor;
a stump cutter;
a drive system interconnecting the motor and the cutter;
a housing configured to substantially enclose the drive system; and
a turret assembly configured to simultaneously pivot the motor, stump cutter, drive system, and housing about a second axis substantially orthogonal to the drive wheel axis;
wherein the housing is configured to avoid contact with the first and second drive wheels as the turret undergoes substantially symmetrical rotation.

2. The stump grinder of claim 1, wherein the housing is disposed proximate the first drive wheel at least one of above and forward of the first drive wheel to thereby avoid interference between the first drive wheel and the housing during turret rotation.

3. The stump grinder of claim 2, wherein turret rotation comprises traversing substantially equal arc segments from right-to-left and from left-to-right.

4. The stump grinder of claim 3, wherein each of the substantially equal arc segments is in the range of about 22° to 30°.

5. The stump grinder of claim 3, wherein each of the substantially equal arc segments is in the range of about 26°.

6. The stump grinder of claim 4, wherein the cutter comprises a cutting wheel configured to rotate in a substantially vertical plane.

7. The stump grinder of claim 6, wherein the drive system comprises a belt configured to apply torque from the motor to the cutting wheel.

8. The stump grinder of claim 7, wherein the turret assembly comprises a turret pivot pin substantially defining the second axis.

9. The stump grinder of claim 8, wherein the turret pivot pin is disposed forwardly of the drive wheel axis.

10. The stump grinder of claim 9, wherein the turret pivot pin is disposed forwardly of the drive wheel axis by a distance in the range of about two to six inches.

11. The stump grinder of claim 3, wherein the motor is disposed within an envelope that does not interfere with the operator's line of sight to the stump.

12. The stump grinder of claim 3, wherein the motor is mounted within a zone that is equal to or less than approximately twenty-four to thirty-six inches above the ground.

13. The stump grinder of claim 12, wherein the motor is further mounted within a zone that is not more than two to eight inches forward of the drive wheel axis.

14. The stump grinder of claim 10, wherein the motor is mounted within a zone that is approximately thirty inches above the ground and approximately five inches forward of the drive wheel axis.

15. The stump grinder of claim 3, further comprising a foldable manual drive handle configured to selectively reduce the height profile of the stump grinder.

16. The stump grinder of claim 15, wherein the foldable manual drive handle comprises a handle portion, a ladder portion, and an actuator configured to selectively pivot the ladder portion into a folded position.

17. A stump grinder comprising:
a turret assembly having a top portion mounted to a chassis and a bottom portion mounted to a drive wheel axel assembly;
a drive wheel mounted to a first side of the drive wheel axel assembly;
a motor mounted to the chassis;
a cutter mounted to the chassis; and
a belt drive housing mounted proximate the first side of the drive wheel axel assembly and interconnecting the motor and the cutter;
wherein the housing is disposed forward of and above the drive wheel to thereby avoid contact with the first and second drive wheels as the turret assembly pivots symmetrically.

18. The stump grinder of claim 17, wherein the turret assembly is configured to pivot about symmetrically about substantially equal arc segments in the range of about 22° to 30°.

19. The stump grinder of claim 18, wherein the turret pivot axis is disposed forwardly of the drive wheel axis by a distance in the range of about two to six inches.

20. The stump grinder of claim 18, wherein the motor is mounted within a zone that is approximately thirty inches above the ground and approximately five inches forward of the drive wheel axel.
